(19) United States
(12) Patent Application Publication
(10) Pub. No.: US 2002/0038291 A1
(43) Pub. Date: Mar. 28, 2002

(54) Certificate evaluation and enhancement process

(76) Inventors: Diane E. Petersen, La Jolla, CA (US); Terry I. Petersen, La Jolla, CA (US)

Correspondence Address: DIANE PETERSEN, 2119 CAMINITO TIBURON, LA JOLLA, CA, 92037, US

(21) Appl. No.: 09/895,112

(22) Filed: Jun. 30, 2001

Related U.S. Application Data
(60) Provisional application No. 60/217,100, filed on Jul. 10, 2000.

(51) Int. Cl. G06F 17/60

(52) U.S. Cl. 705/67

(57) ABSTRACT

A process for evaluating certificates associated with electronic transactions. The certificate, including the objects and the certificate authority, are evaluated to determine the value of their use in electronic transactions. The result of the evaluation is an electronic response indicative of the result, derivation of the input certificate, or request to create a new certificate.

### BACKGROUND OF THE INVENTION

Herein, “network” refers to any electronic communications network, including but not limited to the Internet, Intranets, global area networks (GANs), wide area networks (WANS) and local area networks (LANs), both wired and wireless, connecting computer systems or “nodes”, sometimes referred to here as a “computer”, hand-held personal digital assistants (PDAs) or network appliances. In addition, herein, “transactions” refer broadly to any transfer of information between any nodes of the network, including transfers of “data”, “records” or other information, typically referring to what is apparent to a user at higher layer of network communication. These transactions may take place between virtually any entities each associated with one or more network nodes and may be used in a variety of applications such as electronic data interchange (EDI), electronic commerce, financial information and trading, health and governmental records and filing, and legal communications.

Also herein, “certificate” refers to the current public key cryptography-based technologies such as the ITU X.509 Digital Certificate. The term “certificate authority” or “CA” refers to the entity holding a position of trust within the scope of application to which the certificate is relevant, and verifies, certifies or authenticates the objects and certificate authorities associated to the certificate for the transaction.

The Internet provides the medium connecting a rapidly expanding number of entities such as email correspondence, merchants that sell their products, consumers, and business transactions. There are many incentives for these transactions to be performed over the Internet, including convenience, location, time, cost savings and a greater potential of customers, resulting in increasingly large volumes of transactions over the Internet and other networks. As the popularity of the network increases, transactions performed through these mediums are increasing the awareness that these mediums are fairly insecure, and the industry is seeking solutions to the security concerns. Although the Internet introduces newer methods of conducting business, it also introduces new risks, such as the identity of the party to a transaction, the trustworthiness of that party, and possibility of that party repudiating the transaction.

The use of digital certificates is becoming increasingly popular in satisfying the need for security. These certificates are already successfully used to solve many security concerns, and are readily available from many Certificate Authorities, e.g., VeriSign, GlobalSign, Thawte, Certisign, Digital Signature Trust, etc. A party typically applies for a certificate to a Certificate Authority (CA) and supplies information relating the type of certificate. The CA verifies and authenticates this information, providing a certificate including (a) information and identify of the certified party, (b) the certified party's public key, and (c) information identifying the CA, digitally signed, that is, encrypted with the CA's private key. Then, whenever a party is requested for a verification of that information, the party can send the certificate, assuring that a trusted party has verified the information or objects in the certificate. This certificate provides assuring the identity of the parties to a transaction and provides non-repudiation of a transaction in a network environment. The technologies used in the certificate ensure this through well-known mechanisms such as invented by Rives, Shamir and Adleman (“RSA”). (The particular form of a certificate has been prescribed in a number of industry specifications, such as ITU Rec. X.509 (1993) ISO/IEC 9594-48:1995.)

Because the recipient can only be as assured as the recipient trusts the CA's signature on the certificate, a higher-level CA may itself certify the CA's signature. The higher-level signatures are copied onto each lower level certificate. In this way, layers of CA signatures are stored or written on certificates for lower-level CAs. The recipient of the certificate using the public keys provided with the certificate can review the path or “chain of trust” of signatures CAs that are stored on the certificate. At the highest level, there will be a “root CA”, whose authority is trusted by the recipient. The root CA's public key is initially distributed in a trusted fashion generally “off-line”, such as by face-to-face interaction or included in encryption software, and may be updated later using public key encryption.

The CA functions typically include: (a) verification or qualification of identity—that a digital signature (public key) presented to it in fact belongs to the entity identified with the presentation—and (b) the issuance of a certificate with the CA's digital signature. As in the case of a notary, the CA most likely does not have actual knowledge that a presented signature belongs to a particular entity, but relies on other tests to make such a determination.

The use of a certificate in Internet transactions helps eliminate some security concerns of transactions of the Internet. However, there are limitations and problems associated with sales and other transactions over the network. One fundamental concern is how to verify the identity of a party to a transaction (and whether that party is trustworthy), particularly in a transaction that results in the transfer of value to that party. In typical consumer credit card transactions for purchase of goods by mail order or telephone order, some of the risk is limited by allowing delivery of goods only to a physical address that has some associated trustworthiness (an owned home, as opposed to a post office box). This safeguard is absent where valuable information, such as software or proprietary databases, is made available on a network to the general public and may be downloaded anonymously. Even in the case of physical delivery, there is still the possibility that the addressee party may repudiate the transaction.

Even with a certificate, security may still be a concern. For example, in the case of email correspondence, a person may obtain an email address from a number of email service providers, some of which may not require or perform any verification of the persons' identity. This results in an anonymous email address, where the persons' identity is not necessarily associated with the email address. This allows the misinterpretation of the senders' identity and even the intentional misrepresentation of the identity in email correspondence. To prevent this, many companies provide certificates for email correspondence that provide a level of verification and authentication as to the persons' identity. A person may sign and encrypt his email with the certificate, providing, among other things, some level of verification of the identity of the person who sent the email. The persons' identity, however, is only verified to a certain level of probability, and not as simple as “true” or “false”, because the certificate was obtained from a certificate authority (CA) and different CAs may have different policies for the verification and authentication of the information from the certificate recipient. For example, a person of the name “John A. Smith” may easily obtain an email address of invalidname@email.com from any number email services, enroll for an email certificate from a CA with the name “Invalid Name” and email address of invalidname@email.com. One current popular method for a CA to verify the information is through an email ping, verifying the email address through performing an email correspondence, but the name is often not immediately verified to a high probability. Therefore, it would be possible for “John Smith” to send a recipient an email as with the name of “Invalid Name” from invalidname@email.com. The only information the recipient has is the email, signed by the certificate, verifying the senders email address as invalidname@email.com and, depending upon the CA, the senders name as “Invalid Name”.

This example demonstrates that the certificate, while useful in securing transactions through the cryptography and public-private key technologies, does not in itself solve the security problem. It also shows that parties that use the certificate in the transaction relate the usefulness of the certificate to the policies of the CA and the interpretation. In the above example, the certificate may have implied the name was verified to a greater degree than the recipient may have thought. Or, the CA may have assumed the name was valid because of a credit card transaction, only later to find out that the transaction was fraudulent. The certificate may be revoked later, but this would necessitate the use of a certificate revocation list (CRL) to prove the certificate was not accurate in the first place, and there would be a period of time when the certificate was not revoked, but inaccurate. The problem is that the certificate was issued in the first place, with the CA verifying its accuracy, and the misinterpretation or variance of the CA policies. Also, even if certain objects are correctly verified, a period of time or external acts may invalidate the items that were previously verified.

The verified objects within the certificate may have varying degrees of extent. Also, the verification has varying degrees of reliability, accuracy, or probability, as different CAs have different policies on verification and authentication. In the email example, a users' certificate contains objects stating the name as “Invalid Name” and the email address as invalidname@email.com. One common practice is for a CA to validate the email address through an email ping. This verifies the email address with a high degree of probability. The CAs however, verifies accompanying information, e.g., the name “Invalid Name”, differently, and the probability may range from “not applicable” to “verified by notary”. The recipient, however, only sees the resulting certificate containing the email address as well as the name, and has to evaluate the probability of the objects through looking up the CAs policies, revocation lists, and making a judgment call.

Another example addresses the increased risk of fraud in a financial transaction. In a traditional “brick and mortar” store, the identity of the party is supplemented by the personal appearance and presentation of identification. Also, if the party uses traditional credit cards, those companies help insulate the merchant from fraudulent charges if the merchant can provide proof of the “card present” by running the card through a card reader. When these same transactions occur over the Internet, the merchant is subject to a greater financial risk because the party is not personally presented to the merchant, and the card is not present, and the merchant, not the credit card company, may be responsible for fraudulent charges.

Certificates are becoming increasingly popular in the reduction of fraudulent transactions over the Internet. In this example, the certificate may contain information relative to the transaction, such as the name, address, charge card number, email address and phone number that the certificate authority verifies and authenticates before issuing the certificate to the party. When the party digitally signs a transaction, the merchant has a lower probability of fraud, since the certificate, through the technologies involved and the involvement of the trustee, help assure the identity and information associated with the certificate in relation to the party in the transaction.

However, there are still levels of risk in these transactions for the merchant. Not so much because of the technologies involved with the certificate, such as public-private key and cryptography, but because of the implementation of the technologies. Say for example, a merchant required a party to present a certificate, from one of several current certificate authorities, to verify the party's identity and associated information. From the preceding email example, it is apparent the merchant must demand a different type of certificate. He must be aware of the different CAs and their policies, to ensure he can trust the information. Also, depending upon the policies of the CA, the party may enroll with the name of “John Smith”, but this would not differentiate between “John A. Smith” and “John B. Smith”. This demonstrates the difference in the objects extent; the name is not verified as simple as “yes” or “no”, but the more specific the information, the greater its' value in the reduction of fraud.

A certificates' value in reducing the risk of fraud is relative to the information verified, policies of the CA, and its' implementation. A method of evaluating these certificates as to the their use in transaction over the Internet would solve several security concerns associated with the certificate, objects, objects extent, certificate authority and policies relating to the transaction.

### SUMMARY OF THE INVENTION

This method evaluates the certificates used in electronic transactions over the Net as to their usefulness in associated transactions, by evaluating the certificate, including its objects and policies of the certificate authority. The method accepts a request for evaluation, including one or more certificates. The objects and policies to be evaluated are contained or referenced by the certificate. The objects are evaluated as to their content extent relative to their intended use as indicated in the certificate, the request, and other requests, or rules or data determined by the evaluator to be relative to the evaluation. The evaluation of the certificate may use external information, including database, information retrieved automatically, rules, procedures, or other manipulation of the data to determine its' value relative to the transaction and/or identifiers associated with the certificate. The result of the evaluation is an electronic response that is returned, forwarded, stored, or used in further processes.

Through the evaluation of the certificates, this method provides a greater security in transactions performed over the Internet. This method also allows the centralization of the evaluation process, for example, allowing a corporation or other entity to control the evaluation rather than multiple individual parties.

### BRIEF DESCRIPTION OF THE DRAWINGS

FIG. 1 is a diagram showing the major components involved in the certificate evaluation method.

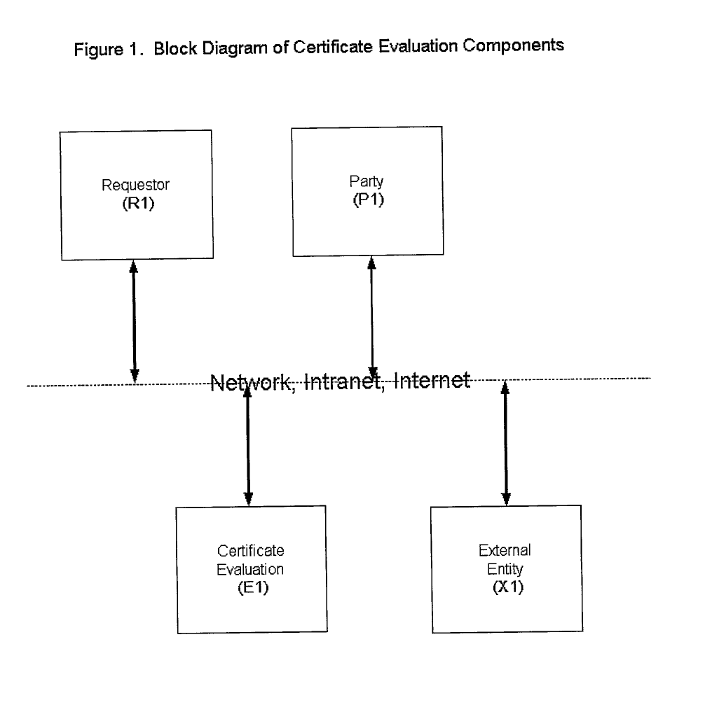

### DETAILED DESCRIPTION

A requestor (R1) sends any certificates to be evaluated, along with any requests to control, direct, influence, substantiate, or supplement the evaluation to the certificate evaluator and enhancement process (E1). The certificate can be an X.509 certificate, including its use of a certificate chain of trusts, other objects verified and authenticated by a trustee, or reference to said objects.

The evaluation (E1) dispositions the request and determines the processing required. A request may include or reference a certificate, instructions or other data influencing the input, evaluation or result. The evaluator (E1) may interact with an external entity (X1), to obtain information pertinent to the evaluation process, or to retrieve a previous evaluation result. E1 evaluates the certificate, including the objects verified by the trustee and may also evaluate the trustee. The objects include common identifiers as in X.509, or other format or method the trustee uses that are meaningful to the CA. The certificate authority, or trustee, is evaluated relative to other trustees, historical performance, and the policies of the trustees in relation to the objects verified by the trustee. The certificate, other verified and authenticated objects or reference to these are evaluated relative to any historical information including certificate revocation lists (CRL), past activity, use or evaluations. Additional parties (P1) may supply input to influence the evaluation or receive the results of the evaluation process.

The objects within and associated to the certificate, are evaluated as to their extent. The extent is evaluated by the identification and specifics of the object. For example, the X.509 identification may use “CN” to identify the name, another identification scheme may use “Name”, or any other identifier understood by the CA. The extent evaluation includes the relationship to the minimum and maximum extents, including comparisons to known objects from other data sources, such as third party databases including mailing lists, accounts, and other information available to public. For example, the content extent of the name “John Smith” is evaluated to knowing the first and last name. This is greater than only knowing the first, or only last name, e.g., “John”, or “Smith”. However the extent has less value than including a middle name or initial, e.g., “John D. Smith” or “John David Smith”. Also, the value of the extent is relative to the uniqueness, or probability of a name contention, e.g., if there are 100 times more “John Smiths” than that of a typical name, then the extent would be relative low. Also, “Jonathan” would have a higher probability than “John”.

The verification and authentication of the objects is evaluated, including an evaluation of certificate authority or trustee and their policies relative to the verification of the objects and request for evaluation. An object is evaluated as to its relevancy to the request and certificate intention. An object that is specifically related to the request or purpose of the certificate has a higher weight than one that does not. For example, an email certificate may contain the name and email address, verified and authenticated by a certificate authority. The email address would be evaluated by information in the certificate and the certificate authorities policy. If the policy of the CA indicated the email address was verified through an email ping (an email correspondence), that item would be evaluated and weighted in relation to other methods available, historical results, and the policies of other CAs. Currently, this would have a high probability, but the evaluation may change as the policies of the CAs evolve. Other objects may include the name of the entity, which may have a low degree of probability if the CA did not determine this to be critical and did not perform an identify verification from a notary.

The said objects are evaluated as to their accuracy by verifying them with additional data sources, such as third party databases and external information sources. For example, if an email certificate contains the email address and name, these objects may be found in other databases that have information with a degree of probability. A customer database may have verified the customers name, address, phone, and email address. Therefore, as an email ping would verify the email address, a cross check would tie the email address to the name, providing a higher probability of the name.

The said objects are evaluated as to their historical use and result. For example, a certificate may currently be valid, have no revocation pending, have a high evaluation from said process, but may have a history of fraudulent use. Any reliable feedback from its use may influence the resulting evaluation, allowing a synergy between recipients of the certificates in further evaluations. Depending on the cause, resulting evaluations also influence future evaluations of other certificates relating to the trustee.

CAs may verify each item that is included in the certificate in a different method. This item may be scored, using a database and rules associated with the policies of the CAs, or methods of authentication, and current validity of the CAs, or the root CA certificate. The item may also be strengthened by further verification of the item with additional methods. In the previous example we have a certificate containing two items: email address and name. Comparing the CA policies and items, we can determine the accuracy of these items, and additionally provide further assurance by performing additional verifications. This would strengthen the item, providing a higher score, or a higher degree of accuracy or verification. Additionally, the resulting item may be a derivative of the original item, such as in the case where one or more items may result in a third, or where one or more original items may be input to a process or information to generate a new item, that may be included in the certificate. This would not only score the original certificate, but enhance its level of verification and may also be used to create a request for a new certificate, optionally importing the current items and public key, to create a new certificate.

Further, a set of rules may determine the scoring or derivative of the certificate. In the said example, a set of rules could be a master set of rules, slave set of rules particular to individual task or item, or used in combination. The certificate is input to the master set of rules. The rules take the name of the CA and items “email address” and “name” to process. The process is a set of rules that determines how to score the certificate using this information and determines the use of additional data or information. For example, the process could take the CA name and the items “name” and “email address”, determine the method of verification used in the original certificate, use an algorithm comparing the two items to determine the probability of a match (e.g., John Smith with johnsmithgemail.com), select procedures and information to determine the strength of an item (e.g., John Smith vs. John D. Smith vs. Mr. Smith), or score or enhance the item (e.g., search databases for item “John Smith” and compare with other items in the certificate), process the item with other items accompanying the certificate (e.g., certificate contains item “name”, and requester submits social security number or mothers maiden name).

The individual items are evaluated relative to other items relative to the certificate and data sources. For example, if the item “John Smith” is determined to have a high probability from CA policies and the email address is johnsmith@email.com, the email address would have a higher degree of probability than just the email address alone or if the name had a low degree of probability. Also, if the email address were verified to be associated with the name with a high degree of probability from an external data source, (e.g., a customer list or public data sources, the name and email would benefit from this and have a higher degree of probability). In another example, a credit card number may be verified by external sources such as a credit card company.

The certificate may refer to an item the evaluator can verify, instead of directly containing that item. This provides for an anonymous certificate, where the certificate relates to verified information, but exposes only selected information instead of all verified information. The certificate is used to acknowledge a request, such as authorize a recipient to check a credit card number or obtain a credit card number from an evaluator. The evaluator may already have verified this information, or may do so dynamically. For example, a person may have a certificate with little or no items verified directly on the certificate, but may have verified data related to this certificate stored at an evaluator. The person may present a credit card number signed with this certificate to a merchant. The merchant could verify this is a valid credit card number with an evaluator that has this information. This allows the person to have one main certificate and to control what information related to it is released, or have multiple certificates related to the same verified information or evaluation method.

The evaluation of the individual items is then weighted by their significance to the intent of the certificate or request. For example, although the email address is high and the name is low, the overall evaluation could still be high, depending upon the certificate intention or associated request, if the main intention is only to verify email address.

Further analysis may include determining the probability of, or deriving of additional information pertinent to the request, certificate, or future use such as a new enhanced certificate, by comparing other known objects with the probability. For example, if the evaluation submits the name “John” and sex of “male” and the name is evaluated to a high degree, then the evaluation of the sex of “male” may be influenced by an external fact of 99.5% of entities with first name “John” are male.

The resulting evaluation may include a “score”, returned with the original certificate information, saved for future evaluations, used to create a new enhanced certificate, and sent or forwarded to another entity. The score includes a summary expressed as a result such as a number, an output including data in the format specified by the evaluator, recommendations, errors or requests for further information. The resulting evaluation may also include a request to generate a new certificate from the original and request, including information gathered during the said evaluation process. The output of the evaluation may include a request resulting in a certificate to be generated that include evaluation results in the format of an object identifier (OID), proprietary format, or certificate extensions to include the result to be included in the certificate in the format of extensible markup language (XML) to target a large audience in a common recognizable format where the result can be readily interpreted in a freeform manner.

Further, a request for a certificate may originate from the original request, certificate, combination of both, or results from the evaluation process, and used to create a certificate dynamically. An input request may only require a subset of the information to be evaluated with the request to result in a request for a new certificate. For example, the input certificate may contain a composite of information including name, address, email, age, sex, phone number and marital status. A request may instruct the evaluation to generate a new certificate request containing only the email address and age, or age category, e.g., “adult”. This would result in a new certificate request that may generate either anonymous certificates or category certificate. A category certificate may include “adult” instead of “21”. An anonymous certificate may include the age or category, but might not include the name, e.g., “John Smith”. This allows verification, while controlling and safeguarding other information pertaining to the verification process.

### Other References

Warwick Ford, Michael S. Baum: Secure Electron Commerce, Prentice Hall PTR, New Jersey 07458, ht://www.prenhall.com

Jalal Feghhi, Jalil Feghhi, Peter Williams, Peter T. Kirstein, Digital Certificates, Applied Internet Security, Addison Wesley Longman, Inc, 1999

ANSI X9.57 Draft: Public Key Cryptography for the Financial Services Industry, Certificate Management

SGML (Standard Generalized Markup Language, defined in ISO 8879:1986),

ISO/IEC 8879:1986, Standard Generalized Markup Language ([iso8879])

1. In a computer having a processor and storage, a computer-implemented process for evaluating certificates, as to their significance and value in associated electronic transactions, comprising the steps of:
receiving, directly or indirectly, input including certificates and/or requests for evaluation;
processing the input by performing the evaluation including evaluation of the inputs extent, accuracy, probability, relevancy and value; and output the result of the evaluation as an electronic response that is returned, forwarded, stored, or used in further processes.

2. A method as in 1, where term “certificates” include X.509 certificates, one or more certificates, certificates in a chain of trust, objects verified by a trustee, objects authenticated by a trustee, or the reference of any of these items.

3. A method as in 1, where the term “requests” include permission or direction in performing an evaluation, supplemental information relative to an evaluation process, an action in reference to current, past or future evaluations.

4. A method as in 1, where the said input is from any source, including a computer, laptop, personal digital assistant (PDA), network appliance and telecom equipment.

5. A method as in 1, where the media of exchange used during the evaluation process, including said input, evaluation and output of result, and interaction during the evaluation process, includes storage devices, disks, memory, Internet, Intranet, network and wireless.

6. A method as in 1, where evaluation includes any combination of the said certificate or multiple certificates, certificate related objects, certificate authorities, certificate objects and requests, either directly or used in reference to.

7. A method as in 1, where the evaluation process includes internal and external sources or procedures, rules, algorithms, data, certificates, items previously verified with associated certificates, and informational databases or querying other sources for information.

8. A method as in 1, where the result of the evaluation is either solicited or unsolicited and includes: an electronic response indicative of the result, summary, derivation of the input certificate or request, a notification, a request to create a new certificate, or a dynamically created certificate.

9. A method as in 1, where the said result of the evaluation is output as any combination of returning, forwarding, or storing the result, partial of the result, or derivation of result.

10. A method as in 1, where the output of the said evaluation, or input to evaluation includes any format including certificate object identifier (OID), proprietary format, code to be executed e.g., Java, HTML, or a markup language including Standard Generalized Markup Language (SGML) and Extensible Markup Language (XML) based formats.

11. A method as in 1, where the process interacts during any stage in the process with an area of central or distributed storage or information storage and retrieval, allowing one or more entities access to or share in the retrieval, processing, modification and deposit of information.

12. A method as in 1, where the said evaluation process interacts, during any stage, with other software or hardware to benefit the process, including smart cards, computer hardware and network devices.

13. A method as in 1, where the evaluations are influenced by historical information including past use, results of usage including successful, unsuccessful, fraudulent, input or feedback from certificate recipients or users, and querying other entities relative to present or historical data relative the evaluation.

14. A method as in 1, where the said evaluation includes multiple evaluators, including arrangements to establish a hierarchy of evaluation.

15. A method as in 1, where the result may be a subset, derivation, or category, evaluated from said input; including verification of information without inclusion of supportive information such as in an anonymous certificate.
